(19) United States
(12) Patent Application Publication
(10) Pub. No.: US 2014/0291889 A1
(43) Pub. Date: Oct. 2, 2014

(54) DEVICE AND METHOD FOR MOLDING FIBER-REINFORCED PLASTIC MEMBER

(71) Applicant: MITSUBISHI AIRCRAFT CORPORATION, Aichi (JP)

(72) Inventors: Tomohiro MURAI, Tokyo (JP); Hiroshi TOKUTOMI, Tokyo (JP)

(73) Assignee: MITSUBISHI AIRCRAFT CORPORATION, Aichi (JP)

(21) Appl. No.: 14/191,920

(22) Filed: Feb. 27, 2014

(30) Foreign Application Priority Data
Mar. 28, 2013 (JP) 2013-69374

(51) Int. Cl. B29C 43/00

(52) U.S. Cl. CPC B29C 43/006
USPC 264/257; 425/150

(57) ABSTRACT

The present invention provides a device and a method for molding fiber-reinforced plastics by which the molding cost can be reduced. A device for molding a fiber-reinforced plastic member 1 of the present invention includes a mold 40, and pressure plates 10 and 20 which press a fiber base material F and a resin R against the mold 40. An adjusting mechanism is configured to be able to adjust the dimensions of gaps G1 and G2 between the mold 40 and the pressure plates 10 and 20, and a fiber-reinforced plastic member 50 is obtained by heating, and then curing or solidifying the resin R impregnated in the fiber base material F.

### BACKGROUND OF THE INVENTION

1. Field of the Invention

The present invention relates to a device and a method for molding a fiber-reinforced plastic member.

2. Description of the Related Art

Fiber-reinforced plastics (FRP) are lightweight and at the same time excellent in mechanical strength, and as such, used for structural members of aircrafts and the like.

One example of the method for molding a fiber-reinforced plastic member is vacuum assisted resin transfer molding (VaRTM) as shown in Japanese Patent No. 4805375.

In the VaRTM method, fibers arranged in a mold are covered with a film, then the space inside the film is depressurized to a predetermined degree of vacuum in order to inject a resin to the inside of the film, and the resin impregnated in the fibers is cured by heating. This method can produce FRP members directly from fibers and resins without using a prepreg which is a semi-cured intermediate material.

A molding jig referred to as a pressure plate is used for pressing the fibers arranged in the mold and the impregnated resin against the mold. The pressure plate is arranged inside the film and presses the fibers and the resin on the basis of a differential pressure between the pressure inside the film and the atmospheric pressure outside the film.

For example, to mold a spar 50 as shown in FIG. 5A, a mold 40 and pressure plates 91, 92, and 93 facing the inner surface of the mold 40 shown in FIG. 5B are used.

The spar 50 includes flanges 51 and 52 which support a skin (not shown), and a web 53 which connects the flanges 51 and 52. A corner part C is formed respectively between the flange 51 and the web 53 and between the flange 52 and the web 53.

The pressure plates 91 to 93 are arranged so as to be adjacent at the corner parts C. A protruding part P, which determines the plate thickness of the flanges 51 and 52, is formed at the ends of the pressure plates 91 and 92 corresponding to the flanges 51 and 52 of the spar 50. The protruding part P defines the dimension of a gap G between the inner surface of the mold 40 and the pressure plates 91 and 92 by being butted against the inner surface of the mold 40. The pressure plates 91 to 93 are machined out integrally with the protruding part P, with high accuracy, from a block of Invar or the like which has low thermal expansion coefficient.

However, when the spar 50 is molded by using the pressure plates 91 to 93, the plate thickness of the flanges 51 and 52 of the spar 50 becomes thicker around the corner part C than the other portions. One factor contributing this is that, when applied from the inside of the corner part C, the pressing force of pressing the fibers and the resin by the pressure plates 91 to 93 becomes insufficient at the corner part C where the pressure receiving surface for receiving the pressing force is narrow. When the pressing force at the corner part C is insufficient, the amount of resin becomes large relative to the fibers and the fiber content at the corner part C decreases.

In order to achieve a predetermined fiber content with a predetermined plate thickness, it is desirable to sufficiently press the corner part C toward the mold 40 by the pressure plates 91 to 93. This requires the gap G between the inner surface of the mold 40 and the pressure plates 91 and 92 to be made smaller, but to do so requires re-creation of the pressure plate with a shorter protruding part P.

However, it is expensive to machine out a pressure plate corresponding to the shape of the spar which has curved surfaces and steps. In addition, since the plate thickness and the fiber content at the corner part are difficult to directly control and, in a way, determined by chance, re-creation is not always successful on the first attempt. Repeatedly re-creating the pressure plate would drive up the molding cost.

On the basis of the above problems, the present invention aims to provide a device and a method for molding a fiber-reinforced plastic member by which the molding cost can be reduced.

### SUMMARY OF THE INVENTION

A device for molding a fiber-reinforced plastic member of the present invention includes: a mold; a molding jig which presses a fiber base material and a resin against the mold; and an adjusting mechanism configured to be able to adjust a gap dimension between the molding jig and the mold, wherein a fiber-reinforced plastic member is obtained by heating, and then curing or solidifying the resin impregnated in the fiber base material.

In the present invention, the gap dimension between the molding jig and the mold is set so as to correspond to a desired plate thickness of a molded article by the adjusting mechanism able to adjust the gap dimension, so that the fiber base material and the resin can be sufficiently pressed by the molding jig, and the fiber base material and the resin can be sufficiently compressed in the gap. Thus, a predetermined plate thickness and a predetermined fiber content can be achieved in the molded article.

When one wishes to change the gap dimension to meet a predetermined fiber content, the gap adjusting mechanism allows trial molding with the same molding jig as many times as needed.

This means that the molding cost can be reduced, as there is no need for re-creating the molding jig to change the gap dimension.

In addition, the gap adjusting mechanism allows the gap to be defined with the thermal expansion and the dimensional accuracy of the molding jig being taken into account, so that the allowable thermal expansion and dimensional accuracy of the molding jig can be relaxed. Accordingly, it is possible to use an inexpensive material for the molding jig and reduce the machining cost. In this respect, too, the molding cost can be reduced.

In the device for molding a fiber-reinforced plastic member of the present invention, the fiber-reinforced plastic member includes a first part, and a second part which is bent with respect to the first part and forms a corner part between the first part and the second part, wherein it is preferable that the mold faces the fiber-reinforced plastic member from the outside of the corner part, while the molding jig faces the fiber-reinforced plastic member from the inside of the corner part.

When a mold facing the fiber-reinforced plastic member from the outside of the corner part is used, the molding jig faces the fiber-reinforced plastic member from the inside of the corner part. For this reason, the fiber content is likely to be non-uniform at the corner part where the pressing force tends to be insufficient compared with the surrounding area. In such cases, the present invention can exert a particularly great effect.

In the device for molding a fiber-reinforced plastic member of the present invention, the molding jig includes a first jig corresponding to the first part, and a second jig corresponding to the second part, wherein at least one of the first jig and the second jig is provided with the adjusting mechanism, and the first jig and the second jig can be arranged so as to be adjacent at the corner part.

By dividing the molding jig into the first jig and the second jig, it becomes easier to produce the molding jig.

In addition, by dividing the molding jig into two or more jigs including the first jig and the second jig, the present invention can be applied to molding of a fiber-reinforced plastic member having two or more corner parts such as one with a C-shaped cross-section.

The adjusting mechanism of the device for molding a fiber-reinforced plastic member of the present invention can be arbitrarily configured; for example, one of the molding jig and the mold may be provided with a protruding part, which protrudes toward the other one, so as to be freely advanced to or retracted from the other one and serve as the adjusting mechanism.

Alternatively, a spacer with a thickness corresponding to the gap may be provided between the molding jig and the mold so as to serve as the adjusting mechanism.

In the device for molding a fiber-reinforced plastic member of the present invention, it is preferable that the fibers and the molding jig are sealed between the mold and a film which covers the molding jig, and that, as a sealed space between the mold and the film is depressurized, the resin is injected from a supply source of the resin into the sealed space.

Since FRP members can be directly obtained from the fibers and the resin by the so-called VaRTM method without using a prepreg, the molding cost can be reduced.

The molding device of the present invention can be used for molding a fiber-reinforced plastic member constituting an aircraft.

For example, the present invention can be applied to molding of various fiber-reinforced plastic members, regardless of the shape, including structural members such as spars and skins (outer panels), and equipment installed in an aircraft.

A molding method of the present invention uses a mold, a molding jig which presses a fiber base material and a resin against the mold, and an adjusting mechanism configured to be able to adjust the gap dimension between the molding jig and the mold, wherein a fiber-reinforced plastic member is obtained by heating, and then curing or solidifying the resin impregnated in the fiber base material.

According to the present invention, the molding cost of fiber-reinforced plastic members can be reduced.

### BRIEF DESCRIPTION OF THE DRAWINGS

FIG. 1A is a cross-sectional view showing a mold and pressure plates according to an embodiment of the present invention;

FIG. 1B is a perspective view of the pressure plates;

FIG. 2A is a view showing a procedure of a molding method;

FIG. 2B is a view showing the procedure of the molding method;

FIG. 3A is a view showing a modified example where a spacer is used as an adjusting mechanism;

FIG. 3B is a view showing an example where the mold is provided with the adjusting mechanism;

FIG. 4A is a view showing an example of application to a plate-like FRP member;

FIG. 4B is a view showing an example of application to an FRP member having one corner part;

FIG. 5A is a perspective view showing a spar in a simplified manner; and

FIG. 5B is an illustrative view of a molding method using conventional pressure plates.

### DETAILED DESCRIPTION OF THE PREFERRED EMBODIMENTS

The following describes an embodiment according to the present invention with reference to the accompanying drawings.

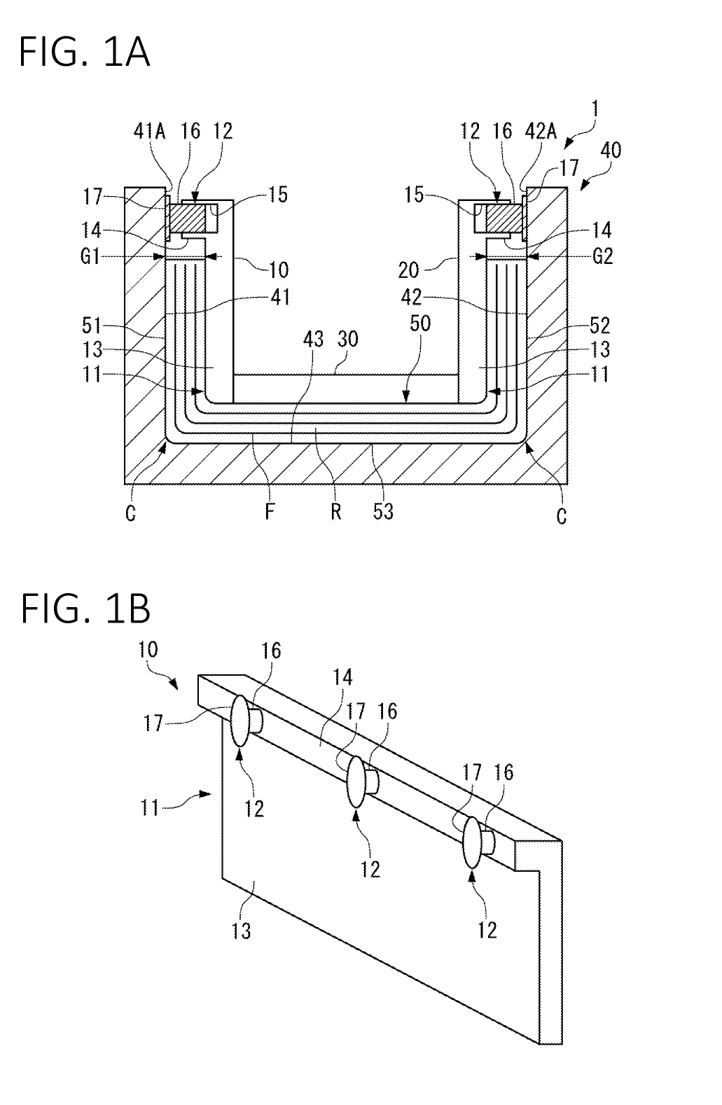

As shown in FIG. 1A, a molding device 1 includes a mold 40, and pressure plates 10, 20, and 30. In this embodiment, a spar 50, which is a structural member of an aircraft, will be molded by using the mold 40 and the pressure plates 10, 20, and 30. The spars 50 are arranged on both of a leading edge and a trailing edge of an aircraft wing. These spars 50 together with a skin (not shown) are installed in a box shape.

The spar 50 is formed of a fiber-reinforced plastic including a fiber base material F and a resin R.

The spar 50 is C-shaped in cross-section, and includes flanges 51 and 52 each supporting the skin, and a web 53 connecting the flanges 51 and 52. Although illustrated in a simplified manner, the spar 50 is formed in a shape conforming with the skin shape.

The flange 51 (first part) and the flange 52 (first part) are bent in the same direction with respect to the web 53 (second part) and face each other. A corner part C is formed respectively between the flange 51 and the web 53 and between the flange 52 and the web 53.

Angles which the flanges 51 and 52 respectively form with the web 53 at the corner parts can be arbitrarily adapted. It is optional whether the angle which the flange 51 forms with the web 53 and the angle which the flange 52 forms with the web 53 are equal or not equal.

The fiber base material F is formed into a sheet shape, and a required number of sheets are stacked according to the plate thickness of the spar 50. Carbon fiber, glass fiber, and the like can be used as the fiber base material F.

The resin R to be impregnated in the fiber base material F is a thermosetting resin which is cured by heating. As the resin R, a thermosetting resin, for example, epoxy, polyimide, polyurethane, and unsaturated polyester can be used. Besides these, a thermoplastic resin which is solidified by heating, such as nylon, polyethylene, polystyrene, polyvinyl chloride, PEEK (polyether ether ketone resin), and PES (polyethersulfone resin) can be used.

The fiber content of the spar 50 is predetermined on the basis of the designed required strength. Hereinafter, the fiber content shall refer to a fiber volume fraction based on the volume. The fiber volume fraction is determined by the ratio between the volume of fibers constituting the fiber base material F and the volume of the resin R impregnated in the fiber base material F.

The mold 40 has a space for accommodating the spar 50, and faces the spar 50 from the outside of the corner part C. The mold 40 includes a bottom surface 43 facing the web 53, a wall surface 41 erected from the bottom surface 43 and facing the flange 51, and a wall surface 42 erected from the bottom surface 43 and facing the flange 52.

On the basis of the shape accuracy of the mold 40, the outer surface of the spar 50 facing the mold 40 is formed with high accuracy. As a result, the skin can be easily installed on the outer surface of the spar 50 without the need for machining the spar 50 or the skin, or interposing a shim. This is an advantage obtained by using the mold 40 which faces the spar 50 from the outside of the corner part C.

The wall surface 41 is formed to be taller than the flange 51 of the spar 50. The area of the wall surface 41 above the upper end of the flange 51 is formed with a receiving surface 41 which supports a butting plate 17 of a plug 12 to be described later. From the viewpoint of machining cost and labor, the receiving surface 41A and the surface of the butting plate 17 to be butted against the receiving surface 41A are preferably machined into a planar shape.

The wall surface 42 is formed similarly to the wall surface 41, and an area above the upper end of the flange 51 is formed with a receiving surface 42A.

The pressure plates 10, 20, and 30 press the fiber base material F and the resin R impregnated in the fiber base material F against the mold 40, and thereby compress mainly the resin R and densify the fiber base material F and the resin R. The pressure plates 10, 20, and 30 are formed of stainless steel (which may optionally be spring material or non-spring material). The pressure plates 10, 20, and 30 can be also formed of other steels, aluminum, Invar, carbon fiber-reinforced resin, glass fiber-reinforced resin, brass, copper, and the like.

These pressure plates 10, 20, and 30 face the spar 50 from the inside of the corner parts C, and are arranged so as to be adjacent at the corner parts C. The inner surface of the spar 50 is formed by the pressure plates 10, 20, and 30.

In this embodiment, atmospheric pressure is utilized to press the fiber base material F and the resin R by the pressure plates 10, 20, and 30.

The pressure plates 10, 20, and 30 are divided as necessary into multiple parts in the lengthwise direction of the spar 50 (in the direction perpendicular to the plane of FIG. 1A).

As shown in FIG. 1B, the pressure plate 10 (first jig) corresponding to the flange 51 of the spar 50 includes a plate 11, and a plug 12 installed to the plate 11.

The plate 11 includes a plate main body 13, and a protruding part 14 which protrudes toward the wall surface 41 of the mold 40. Although the plate main body 13 and the protruding part 14 are integrally formed, separately formed plate main body 13 and protruding part 14 may be joined and integrated.

The plate main body 13 is formed so as to cover the flange 51 and be taller than the flange 51.

The protruding part 14 is provided continuously along the upper end of the plate main body 13 in the longitudinal direction of the spar 50. An engaging recess part 15 for receiving the plug 12 is formed in the protruding part 14 in the thickness direction of the plate main body 13. In place of the engaging recess part 15, a through-hole may be formed which passes through the protruding part 14 in the thickness direction of the plate main body 13.

The protruding part 14 and the plug 12 define the plate thickness of the spar 50 by being interposed between the plate main body 13 and the wall surface 41.

The plug 12 serves as an adjusting mechanism for adjusting the dimension of a gap G1 between the wall surface 41 of the mold 40 and the pressure plate 10.

The plug 12 is provided at multiple positions of the protruding part 14 at intervals in the extending direction of the protruding part 14. A required number of the plugs 12 are provided at required positions so as to withstand the force applied by the atmospheric pressure and maintain the adjusted gap G1 during molding.

The plug 12 includes a columnar plug main body 16 and the butting plate 17 provided at the leading end of the plug main body 16. It is preferable that the plug main body 16 and the butting plate 17 are formed of or surface-treated with such a material that even when the resin R is attached, it can be easily removed.

The plug main body 16 can be advanced to and retracted from the wall surface 41, with the base end side of the plug main body being inserted into the engaging recess part 15 of the protruding part 14. The plug main body 16 is advanced or retracted non-stepwise or stepwise, and engaged with the protruding part 14 at positions with different lengths of protrusion (hereinafter, protrusion length) toward the wall surface 41 from the engaging recess part 15.

The mechanism for advancing/retracting and engaging the plug main body 16 can be arbitrarily configured. For example, each of the outer circumference of the plug main body 16 and the inner circumference of the engaging recess part 15 may be formed with a thread. Alternatively, one of the outer circumference of the plug main body 16 and the inner circumference of the engaging recess part 15 may be formed with an annular rib, while the other one may be formed with a groove in which the rib engages, and multiple pairs of these rib and groove may be arranged at intervals in the axial direction of the plug main body 16.

The butting plate 17 is formed in a circular shape with a diameter larger than the diameter of the plug main body 16, and is butted against the receiving surface 41A of the wall surface 41. The butting plate 17 is provided on the plug main body 16 so that the center of the butting plate 17 coincides with the shaft center of the plug main body 16. The shape of the butting plate 17 is not limited to a circular shape and can be arbitrarily adapted.

When the plug main body 16 is advanced or retracted, the distance from the plate main body 13 to the butting plate 17 changes, so that the dimension of the gap G1 between the wall surface 41, against which the butting plate 17 is butted, and the plate main body 13 is adjusted.

The plug main bodies 16 of the plugs 12 provided in the protruding parts 14 can be separately advanced and retracted. The gap G1 between the wall surface 41, against which the butting plate 17 is butted, and the plate main body 13 is adjusted to different dimensions for portions of different thicknesses of the spar 50.

In place of the butting plate 17, a butting plate with the same diameter as the diameter of the plug main body 16 can also be used. Alternatively, the plug 12 may have no butting plate.

Next, the pressure plate 20 (first jig) corresponds to the flange 52 of the spar 50. As the pressure plate 20 is configured similarly to the above-described pressure plate 10, each component of the pressure plate 20 will be denoted by the same reference sign as in the pressure plate 10 and will not be described. By advancing and retracting the plug main body 16 provided in the protruding part 14 of the pressure plate 20, the dimension of a gap G2 between the wall surface 42 and the plate main body 13 can be adjusted.

The other pressure plate 30 (second jig) is formed in a shape conforming with the web 53 of the spar 50. This pressure plate 30 is formed to have a width equivalent to the distance between the plate main bodies 13 and 13 of the respective pressure plates 10 and 20. The both ends of the pressure plate 30 positioned respectively at the corner parts C are adjacent to the pressure plates 10 and 20 across a clearance (not shown).

The following describes a method for molding the spar 50.

In this embodiment, the VaRTM method is performed, in which a sealed space is depressurized to a predetermined degree of vacuum by evacuation, in order to assist injection of the resin R as well as to apply a pressing force to the fiber base material F and the resin R by the differential pressure between the pressure inside the depressurized space and the atmospheric pressure.

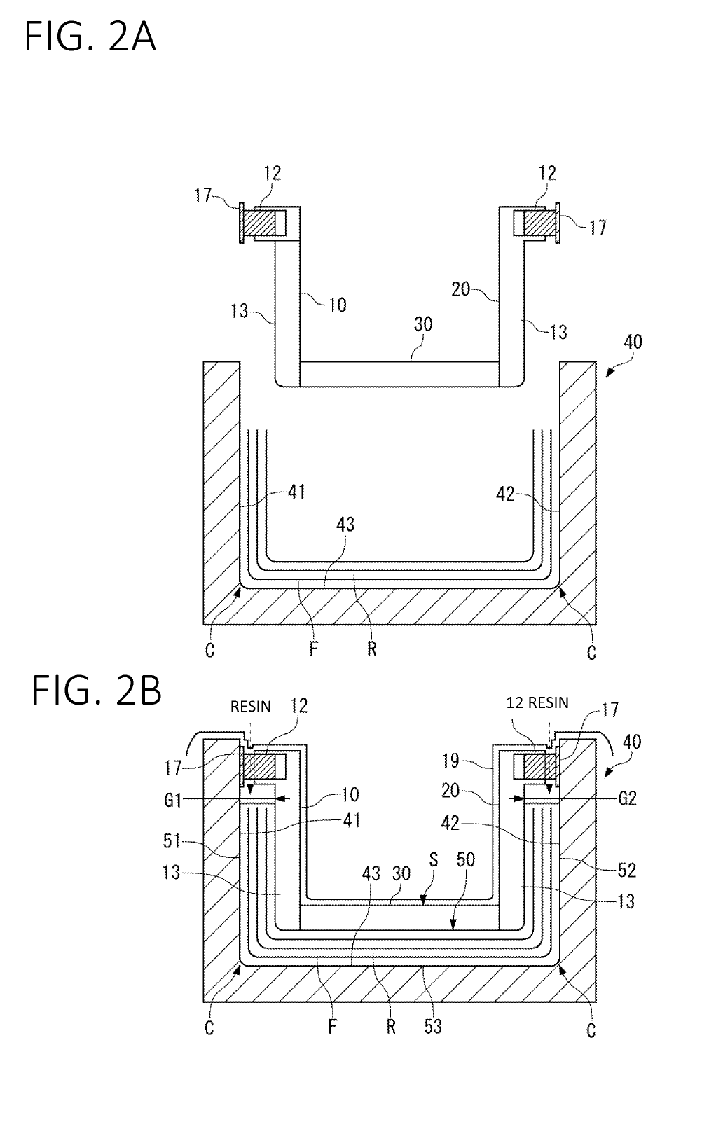

In this case, as shown in FIG. 2B, the fiber base material F arranged in the mold 40 and the pressure plates 10, 20, and 30 are sealed between the mold 40 and a bag film 19 which covers the pressure plates 10, 20, and 30. Thus, a sealed space S to be depressurized is formed between the bag film 19 and the mold 40.

The sealed space S is connected to a supply source of the resin R through an injection channel (not shown). In order to spread the resin R throughout the inside of the sealed space S, it is preferable that injection ports communicating with the injection channel are formed at multiple positions inside the sealed space S.

In molding of the spar 50, the gaps G1 and G2 between the mold 40 and the pressure plates 10 and 20 are adjusted to achieve a desired fiber content. The gaps G1 and G2 correspond respectively to the plate thicknesses of the flanges 51 and 52 of the spar 50.

Here, the fiber content depends on various factors such as thermal expansion or dimensional tolerance of the pressure plates 10, 20, and 30, or fluctuations in the atmospheric pressure. When the fiber base material F and the resin R are not sufficiently pressed against the mold 40 due to these factors, the resin is not sufficiently compressed and the volume ratio of the resin R relative to the fibers increases. As a result, the plate thickness increases and the fiber content decreases accordingly.

While the fiber content is preferably constant, or within a certain tolerance range, throughout the portions of the member, when the pressing force unevenly acts on the fiber base material F and the resin R, the fiber content becomes non-uniform.

In particular, as in this embodiment where the fiber base material F and the resin R are pressed against the mold 40 by the pressure plates 10, 20, and 30 from the inside of the corner parts C, the pressing force at the corner parts C is likely to be insufficient compared with the surrounding area of the corner parts C, due to the narrow pressure receiving surface for receiving the pressing force. Consequently, the resin R is not sufficiently compressed at the corner parts C, and when extra resin R flows from the surrounding area to the corner parts C, the plate thickness at the corner parts C becomes larger than the surrounding area. Thus, as the fiber content becomes lower at the corner parts C than the surrounding area, the fiber content becomes non-uniform.

As described above, although the fiber content depends on various factors, it is necessary to achieve the fiber content adequate for the required strength.

Therefore, in this embodiment, by adjusting the dimensions of the gaps G1 and G2 corresponding respectively to the plate thicknesses of the flanges 51 and 52 of the spar 50, the fiber base material F and the resin R are sufficiently pressed against the mold 40. For this purpose, the gaps G1 and G2 are made narrower by making shorter the protrusion length of the plug 12 of each of the pressure plates 10 and 20.

The atmospheric pressure almost evenly acts on the pressure plates 10, 20, and 30 through the bag film 19. Accordingly, when the plate thickness of the flange 51 corresponding to the pressure plate 10 and the plate thickness of the flange 52 corresponding to the pressure plate 20 are equal, the dimensions of the gaps G1 and G2 can be set to an equal dimension.

On the other hand, the gap between the pressure plate 30 and the bottom surface 43 is determined by the balance among the thickness of the stacked fiber base material F, the pressing force applied to the fiber base material F and the resin R, and the tension due to interlayer friction of the fiber base material F against the pressing force.

The following describes a procedure for molding the spar 50 by using the pressure plates 10, 20 and 30.

As shown in FIG. 2A, the fiber base material F is stacked on the inner surface of the mold 40. The fiber base material F is continuous across the wall surface 41, the bottom surface 43, and the wall surface 42, and bent at the corner parts C.

Next, the pressure plates 10, 20, and 30 are placed on the fiber base material F. At this time, for example, after the pressure plate 10 and the pressure plate 20 are arranged on the fiber base material F, the pressure plate 30 is arranged between the pressure plates 10 and 20. The pressure plate 30 is positioned in the width direction of the mold 40 by being sandwiched between the lower ends of the pressure plates 10 and 20.

Subsequently, as shown in FIG. 2B, the space between the mold 40 and the bag film 19 which is put over the pressure plates 10, 20, and 30 is sealed with a sealant tape or the like, to form the sealed space S between the mold 40 and the bag film 19. Then, the sealed space S is depressurized by evacuation through a valve (not shown) provided in the bag film 19.

The pressure plates 10, 20, and 30 press the fiber base material F and the resin R against the mold 40 by their own weights with the addition of the differential pressure between the sealed space S separated by the bag film 19 and the atmospheric pressure.

As the butting plate 17 of the plug 12 of the pressure plate 10 is butted against the wall surface 41, the gap G1 is defined. Similarly, as the butting plate 17 of the plug 12 of the pressure plate 20 is butted against the wall surface 42, the gap G2 is defined.

At this time, since the butting plate 17 is provided in the plug main body 16, the gaps G1 and G2 can be maintained without the leading end of the plug main body 16 digging into the wall surface 41. In addition, even when bending stress is applied to the plug main body 16, as the butting plate 17 butted against the wall surface 41 resists the bending stress, the gaps G1 and G2 can be maintained.

Meanwhile, as the sealed space S is depressurized, a predetermined amount of liquid resin R is injected from the supply source of the resin R into the sealed space S. The resin R is impregnated into the fiber base material F.

Since the gaps G1 and G2 are adjusted on the basis of the protrusion length of the plug 12 as described above, the entire fiber base material F and resin R including the corner parts C are pressed by the pressure plates 10, 20, and 30. Thus, the entire fiber base material F and resin R are sufficiently compressed.

After that, the resin R is cured by heating. Evacuation is preferably continued also during this process.

Any heating device can be used to heat the resin R. For example, a mat with an embedded heater may be placed on the bag film 19 to heat the resin R. Other examples include an oven capable of accommodating the mold 40, or a heat gun sending hot air to the pressure plates 10, 20, and 30.

After being cured to a predetermined hardness, the resin R is integrated with the fiber base material F.

In this way, molding of the spar 50 has been completed.

As has been described above, the pressure plates 10 and 20 which can adjust the gaps G1 and G2 are used in this embodiment. By means of the adjusting mechanisms provided in the pressure plates 10 and 20, the gaps G1 and G2 can be set to such a dimension that the entire fiber base material F and resin R including the corner part C can be sufficiently pressed by the pressure plates 10, 20, and 30. As a result, the fiber base material F and the resin R are sufficiently compressed in the gaps G1 and G2, so that a predetermined plate thickness and a predetermined fiber content can be achieved in the entire molded spar 50 including the corner parts C.

Here, when one wishes to change the dimensions of the gaps G1 and G2 to meet a predetermined fiber content, the adjusting mechanisms for the gaps G1 and G2 allow trial molding of the spar 50 with the same pressure plates 10 and 20 as many times as needed.

This means that the molding cost can be kept down, as there is no need for re-creating the pressure plates 10 and 20 to change the dimension of the gaps G1 and G2.

In addition, the adjusting mechanisms for the gaps G1 and G2 allow the gaps G1 and G2 to be defined with the thermal expansion and the dimensional accuracy of the pressure plates 10 and 20 being taken into account, so that the allowable thermal expansion and dimensional accuracy of the pressure plates 10 and 20 can be relaxed. Accordingly, it is possible to use an inexpensive material for the pressure plates 10 and 20, and reduce the machining cost. In this respect, too, the molding cost can be reduced.

The adjusting mechanisms for the gaps G1 and G2 can also be used for changing the plate thickness of the spar 50. More specifically, the spar 50 can be molded in different plate thicknesses by adjusting the dimensions of the gaps G1 and G2, without the need for modifying the pressure plates 10 and 20.

### [Modified Examples of Adjusting Mechanism]

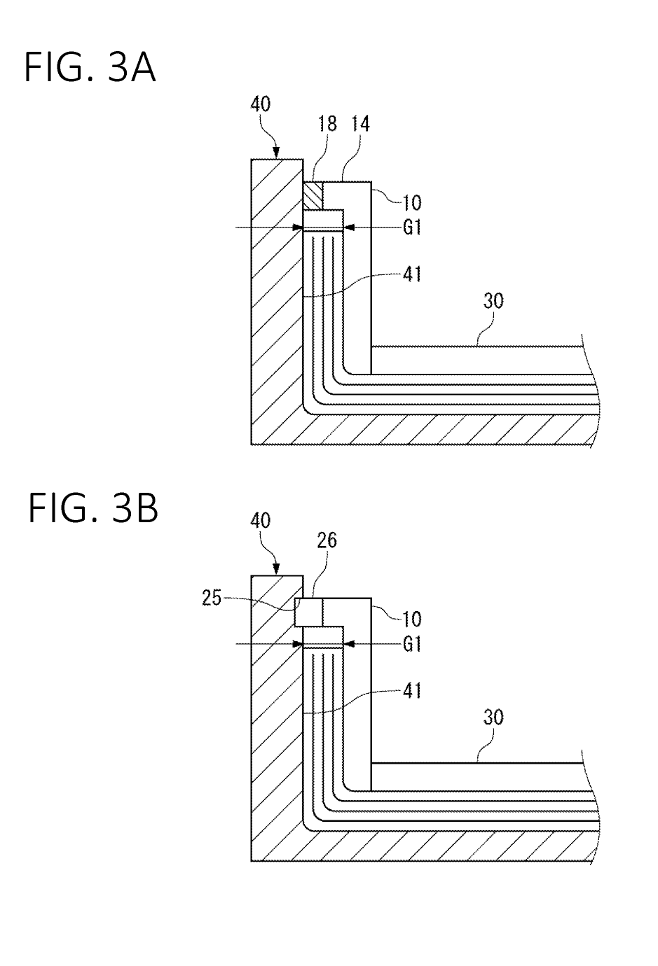

While the plug 12 is used as the adjusting mechanism of the pressure plates 10 and 20 in the above embodiment, a plate-like spacer 18 as shown in FIG. 3A can also be used in place of the plug 12.

The spacer 18 can be formed in a predetermined thickness by a single plate or a stack of multiple thin plates.

When the spacer 18 is interposed between the protruding part 14 of the pressure plate 10 and the wall surface 41 of the mold 40, the dimension of the gap G1 between the wall surface 41 and the plate main body 13 is defined.

Thus, the dimension of the gap G1 can be adjusted by adjusting the thickness of the spacer 18 or replacing the spacer 18 with another spacer 18 having a different thickness.

If a holding part which can detachably hold the spacer 18 is provided in the protruding part 14 or the wall surface 41, the gap G1 can be more easily adjusted.

FIG. 3B shows an example where a plug 26 is provided in the mold 40 as the adjusting mechanism.

The plug 26 is engaged in an engaging recess part 25 formed in the inner wall of the mold 40. This plug 26 can be engaged in the engaging recess part 25 after the fiber base material F is arranged in the mold 40.

The gap G1 can be adjusted by advancing/retracting the plug 26 to/from the pressure plate 10 so as to change the protrusion length of the plug 26 from the engaging recess part 25.

### [Examples of Application to FRP Members of Other Shapes]

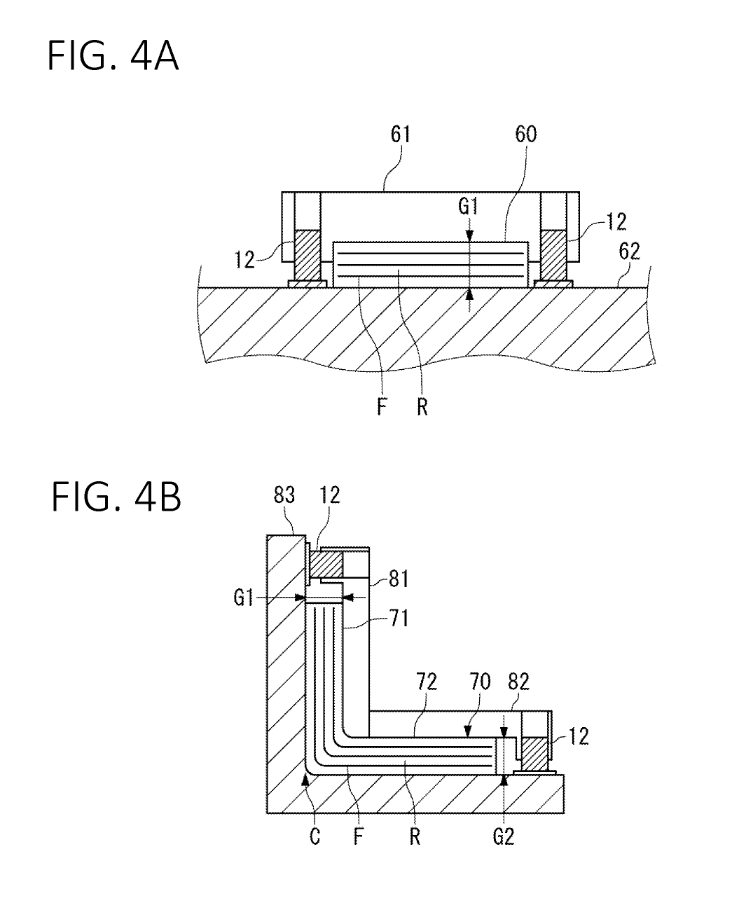

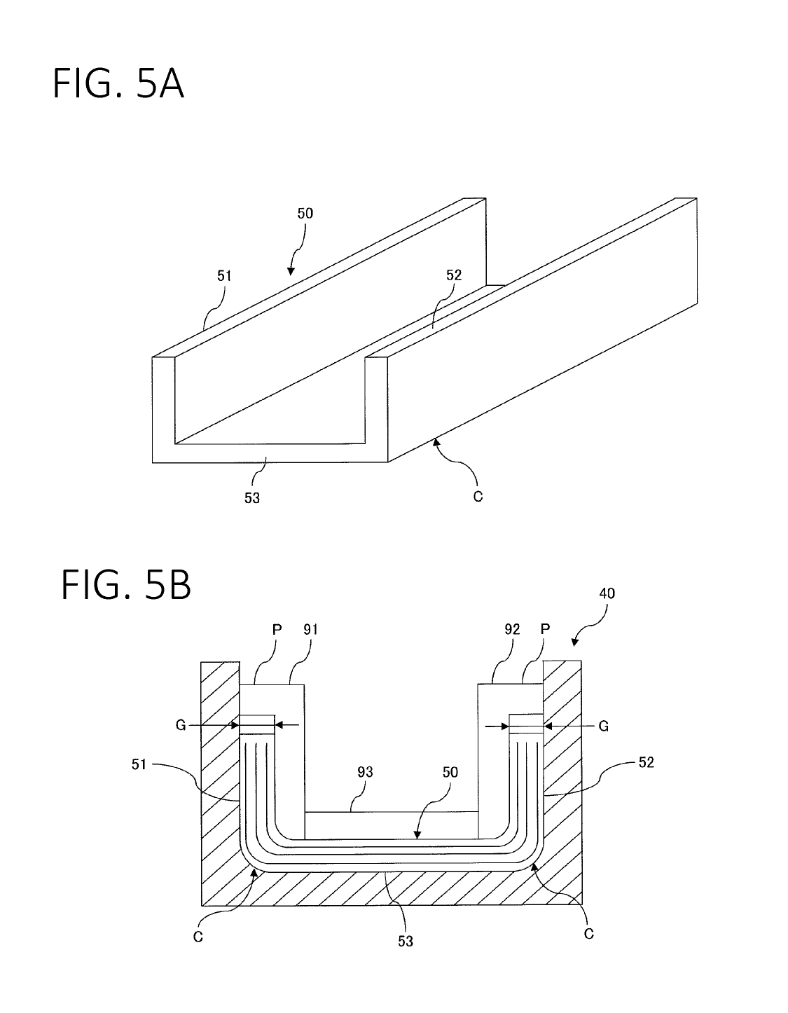

FIG. 4A shows an example where the present invention is applied to a plate-like FRP member 60.

To mold the FRP member 60, a mold 62, and a pressure plate 61 which includes the plug 12 as the adjusting mechanism for the gap G1 can be used.

The plug 12 can be provided at positions as required for maintaining the gap G1, such as at both ends or four corners of the pressure plate 61.

When the dimension of the gap G1 is adjusted by the plug 12, the fiber base material F and the resin R can be sufficiently pressed against the mold 62 by the pressure plate 61, so that a predetermined fiber content can be achieved with a predetermined plate thickness.

If the protrusion lengths of the plugs 12 provided at both ends of the pressure plate 61 are separately changed, the pressure plate 61 is inclined. This can be utilized to form an FRP member which gradually changes in plate thickness.

FIG. 4B shows an example where the present invention is applied to an FRP member 70 having an L-shaped cross-section.

The FRP member 70 includes a first part 71, and a second part 72 which is bent with respect to the first part 71. A corner part C is formed between the first part 71 and the second part 72.

To mold the FRP member 70, a mold 83, a pressure plate 81 (first jig) corresponding to the first part 71, and a pressure plate 82 (second jig) corresponding to the second part 72 can be used.

The pressure plate 81 includes the plug 12 as the adjusting mechanism for the gap G1. The pressure plate 82 includes the plug 12 as the adjusting mechanism for the gap G2. The pressure plates 81 and 82 are arranged so as to face the FRP member 70 to be molded from the inside of the corner part C and be adjacent at the corner part C.

By adjusting the dimensions of the gaps G1 and G2 by the plug 12 of each of the pressure plates 81 and 82, the fiber base material F and the resin R can be sufficiently pressed against the mold 83 by the pressure plates 81 and 82. Thus, a predetermined fiber volume fraction can be achieved with a predetermined plate thickness in the molded FRP member 70.

The pressure plates 81 and 82 can also be integrally formed. In this case, too, the same advantage can be obtained by adjusting the gaps G1 and G2 by the plugs 12.

In the molding method of the present invention, it is not absolutely necessary to utilize the atmospheric pressure to press the fiber base material F and the resin R.

For example, in the example shown in FIG. 4A, the FRP member 60 can also be molded by restricting the mold 62 and the pressure plate 61 across the gap G1. In this case, for example, a weight can be placed on the pressure plate 61. Alternatively, the mold 62 and the pressure plate 61 may be fastened with a rod.

Further, a prepreg may be used in place of the liquid resin R and the fiber base material F in the present invention.

Other than the above, the configurations named above can be selectively adopted or abandoned, or replaced as necessary with another configuration within the scope of the present invention.

The present invention can be widely used for molding various members, other than members of an aircraft, such as windmill blades.

What is claimed is:

1. A device for molding a fiber-reinforced plastic member, comprising:
a mold;
a molding jig which presses a fiber base material and a resin against the mold; and
an adjusting mechanism configured to be able to adjust a gap dimension between the molding jig and the mold, wherein
a fiber-reinforced plastic member is obtained by heating, and then curing or solidifying the resin impregnated in the fiber base material.

2. The device for molding a fiber-reinforced plastic member according to claim 1, wherein
the fiber-reinforced plastic member comprises a first part, and a second part which is bent with respect to the first part and forms a corner part between the first part and the second part,
the mold faces the fiber-reinforced plastic member from the outside of the corner part, and
the molding jig faces the fiber-reinforced plastic member from the inside of the corner part.

3. The device for molding a fiber-reinforced plastic member according to claim 2, wherein
the molding jig includes a first jig corresponding to the first part, and a second jig corresponding to the second part,
at least one of the first jig and the second jig is provided with the adjusting mechanism, and
the first jig and the second jig are arranged so as to be adjacent at the corner part.

4. The device for molding a fiber-reinforced plastic member according to claim 1, wherein one of the molding jig and the mold is provided with a protruding part, which protrudes toward the other one, so as to be freely advanced to or retracted from the other one and serve as the adjusting mechanism.

5. The device for molding a fiber-reinforced plastic member according to claim 2, wherein one of the molding jig and the mold is provided with a protruding part, which protrudes toward the other one, so as to be freely advanced to or retracted from the other one and serve as the adjusting mechanism.

6. The device for molding a fiber-reinforced plastic member according to claim 3, wherein one of the molding jig and the mold is provided with a protruding part, which protrudes toward the other one, so as to be freely advanced to or retracted from the other one and serve as the adjusting mechanism.

7. The device for molding a fiber-reinforced plastic member according to claim 1, wherein a spacer with a thickness corresponding to the gap is provided between the molding jig and the mold so as to serve as the adjusting mechanism.

8. The device for molding a fiber-reinforced plastic member according to claim 2, wherein a spacer with a thickness corresponding to the gap is provided between the molding jig and the mold so as to serve as the adjusting mechanism.

9. The device for molding a fiber-reinforced plastic member according to claim 3, wherein a spacer with a thickness corresponding to the gap is provided between the molding jig and the mold so as to serve as the adjusting mechanism.

10. The device for molding a fiber-reinforced plastic member according to claim 1, wherein
the fiber base material and the molding jig are sealed between the mold and a film which covers the molding jig, and
as a sealed space between the mold and the film is depressurized, the resin is injected from a supply source of the resin into the sealed space.

11. The device for molding a fiber-reinforced plastic member according to claim 1, wherein the fiber-reinforced plastic member is a member constituting an aircraft.

12. A method for molding a fiber-reinforced plastic member according to claim 1, using: a mold; a molding jig which presses a fiber base material and a resin against the mold; and an adjusting mechanism configured to be able to adjust a gap dimension between the molding jig and the mold, wherein
a fiber-reinforced plastic member is obtained by heating, and then curing or solidifying the resin impregnated in the fiber base material.
